(19) United States
(12) Patent Application Publication
(10) Pub. No.: US 2026/0278626 A1
(43) Pub. Date: Sep. 17, 2026

(54) AI-BASED SUPPLIER MANAGEMENT SYSTEM

(71) Applicant: SAUDI ARABIAN OIL COMPANY, Dhahran (SA)

(72) Inventor: Mustafa M. Alareed, Safwa (SA)

(73) Assignee: SAUDI ARABIAN OIL COMPANY, Dhahran (SA)

(21) Appl. No.: 19/076,351

(22) Filed: Mar. 11, 2025

(51) Int. Cl. G06Q 30/0202; G06Q 10/0631; G06Q 10/0639; G06Q 30/0203

(52) U.S. Cl. CPC G06Q 30/0202; G06Q 10/063112; G06Q 10/06393; G06Q 30/0203

(57) ABSTRACT

An artificial intelligence (AI)-based system and associated method for supplier management. The method includes obtaining a specification including one or more needs associated with a project and extracting requirements for the project based on the specification. The requirements include a type of service or product, a quantity of the type of service or project, and a delivery schedule. The method further includes determining a supplier list with at least one potential supplier based on the requirements and supplier data and generating, using a questionnaire generator, a questionnaire based on the requirements and questionnaire response history. The method further includes transmitting the questionnaire to, and receiving a response from, each of the at least one potential suppliers and determining a predicted performance for each of the at least one potential suppliers. The method further includes selecting a supplier from the at least one potential suppliers based on the predicted performance.

### BACKGROUND

Procurement of services and material goods is a process executed by many organizations. Often, this and associated operations such as supply chain management require, at a minimum, operations such as: determination of requirements of the organization from a specification; identification of potential suppliers to supply the requirements (e.g., as a service and/or material good); selection of a supplier based on an evaluation of the supplier; and performance monitoring of the selected supplier.

The above-listed processes, when applied to a project of an organization, are labor intensive and are often performed manually with potential to introduce human error. Large organizations can have hundreds of independent projects per year. Further, execution of the above-listed process often require the manual integration of data scattered over multiple databases and systems such as supply chain management systems, internal business accounting systems, and commercial System Analysis Program (SAP) development systems.

Accordingly, there exists a need for an intelligent system that can select, use, and monitor the performance of a supplier in view of the requirements of the organization (e.g., for a given project).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for supplier management. The method includes obtaining a specification including one or more needs associated with a project and extracting, using a first model, requirements for the project based on the specification. Extracting the requirements with the first model includes parsing and processing the specification with a natural language processing method. The requirements include a type of service or product, a quantity of the type of service or project, and a delivery schedule. The method further includes determining, using a second model, a supplier list with at least one potential supplier based on, at least, the requirements and supplier data. Determining the supplier list with the second model includes identifying the at least one potential supplier that supplies the type of service or product based on the supplier data. The method further includes generating, using a third model as part of a questionnaire generator, a questionnaire based on, at least, the requirements and questionnaire response history. The method further includes transmitting the questionnaire to each of the at least one potential suppliers and receiving a questionnaire response from each of the at least one potential suppliers. The method further includes determining, using a fourth model, a predicted performance for each of the at least one potential suppliers based on the respective questionnaire response for each of the at least one potential suppliers. The method further includes selecting a selected supplier from the at least one potential suppliers based on the predicted performance of each of the at least one potential suppliers.

Embodiments disclosed herein generally relate to an artificial intelligence (AI)-based supplier management system. The AI-based supplier management system includes a user interface and a database storing supplier data, historical data, market data, and questionnaire response history. The AI-based supplier management system further includes a requirements determination system configured to obtain, using the user interface, a specification and determine, using a first AI model included in the requirements determination system, requirements for a project based on the specification. The requirements include a type of service or product, a quantity of the type of service or project, and a delivery schedule. The AI-based supplier management system further includes a supplier identification system configured to determine, using a second AI model included in the supplier identification system, a supplier list having at least one potential supplier based on, at least, the requirements and the supplier data. Determining the supplier list with the second model includes identifying the at least one potential supplier that supplies the type of service or product based on the supplier data. The AI-based supplier management system further includes a questionnaire generator configured to generate, using a third AI model as part of the questionnaire generator, a questionnaire based on, at least, the requirements and the questionnaire response history. The AI-based supplier management system further includes a supplier evaluation system configured to determine a predicted performance for each of the at least one potential suppliers based on the respective questionnaire response for each of the at least one potential suppliers using a fourth AI model included in the supplier evaluation system. The supplier evaluation system is further configured to select a selected supplier from the at least one potential suppliers based on the predicted performance of each of the at least one potential suppliers.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an AI-based supplier management system, in accordance with one or more embodiments.

FIGS. 2 and 3 depict a flowchart in accordance with one or more embodiments.

FIG. 4 depicts a feedback loop of a questionnaire generator, in accordance with one or more embodiments.

FIG. 5 depicts a method in accordance with one or more embodiments.

FIG. 6 depicts a neural network in accordance with one or more embodiments.

FIG. 7 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “predicted performance” can include reference to one or more such performance predictions.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

Embodiments disclosed herein relate to an artificial intelligence (AI)-based supplier management system that, among other things, determines a set of requirements (“requirements”) for a given project of an organization by parsing, using at least one AI model, a project specification. The AI-based supplier management system further determines, based on the requirements, at least one potential supplier capable of providing a product or service in accordance with the requirements and a set of criteria for evaluating each of the at least one potential suppliers. The AI-based supplier management system further intelligently queries each of the at least one potential suppliers using an up-to-date, and in some instances an interactive or dynamic, questionnaire generated using another AI model, where the questionnaire is used to determine a predicted performance for each of the at least one potential suppliers. The AI-based supplier management system can further select a supplier from the at least one potential suppliers to provide the determined product or service based on the predicted performances. Other aspects of the AI-based supplier management system, including additional AI models that it encompasses, are discussed later in the instant disclosure. In accordance with one or more embodiments, the AI-based supplier management system provides streamlined and heavily (if not entirely) automated processes for supplier discovery, supplier evaluation, and supplier selection to improve the procurement process of an organization (e.g., providing an agile procurement process). As will be described, the AI-based supplier management system includes at least one AI model that produces tailored questionnaires including one or more queries and associated evaluation criteria so that potential suppliers can be evaluated based on unique (i.e., not duplicated or redundant) and up-to-date data. Consequently, the AI-based supplier management system aids in lowering the risk associated with management decisions regarding supplier selection by removing human bias (e.g., decisions made based on emotional factors such as anxiety). Further, the full-time support (e.g., determination of real-time performance) provided by the AI-based supplier management system reduces human intervention and associated delays and can further generate an alert in response to detecting an issue (e.g., program or schedule delay) and/or anomaly (e.g., degradation in performance, inaccurate or large change in a parameter).

Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence, or AI model or AI-based, will be adopted herein, however, one skilled in the art will recognize that the concepts and methods detailed hereafter are not limited by this choice of nomenclature.

AI model types may include, but are not limited to, neural networks, logistic regression, random forests, generalized linear models, convolutional neural networks, transformers or other sequence-to-sequence models, k-means clustering, support vector machines, reinforcement models, and time-series models including recurrent neural networks. AI model types are usually associated with additional “hyperparameters” that further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.” Greater detail regarding the use of one or more AI models, in accordance with one or more embodiments, will be provided below in the present disclosure.

Procurement of services and material goods is a process executed by many organizations. Often, this and associated operations such as supply chain management require, at a minimum, operations such as: determination of requirements of the organization from a specification; identification of potential suppliers to supply the requirements (e.g., as a service and/or material good); selection of a supplier based on an evaluation of the supplier; and performance monitoring of the selected supplier.

The above-listed processes, when applied to a project of an organization, are labor intensive and are often performed manually with potential to introduce human error. Large organizations can have hundreds of independent projects per year. Further, execution of the above-listed process often require the manual integration of data scattered over multiple databases and systems such as supply chain management systems, internal business accounting systems, and commercial System Analysis Program (SAP) development systems such as SAP Ariba for communicating with suppliers.

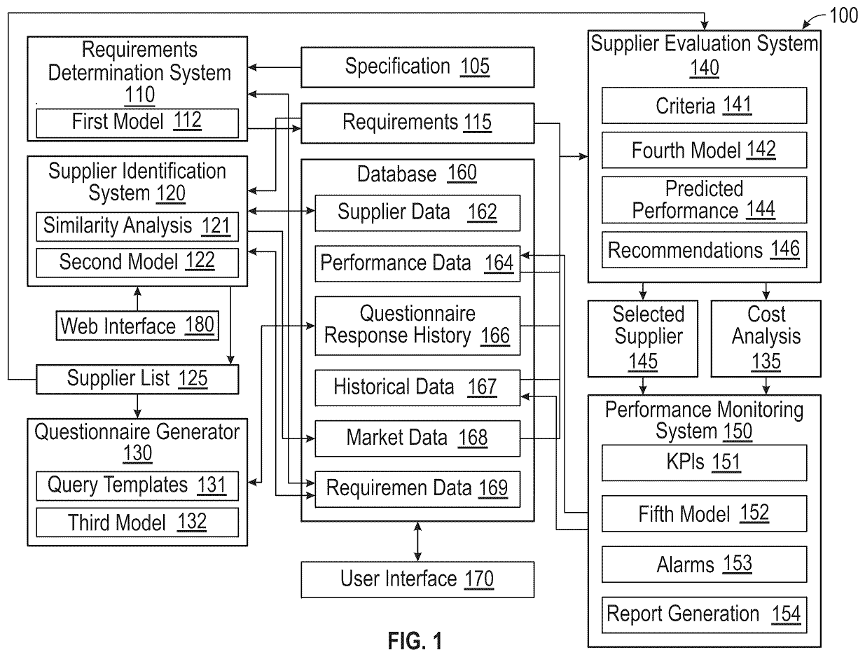

FIG. 1 depicts an AI-based supplier management system (100) in accordance with one or more embodiments. In FIG. 1, AI-based supplier management system (100) is depicted as being comprised of various components and/or modules, where the components and/or modules may interact with each other. One with ordinary skill in the art will recognize that the partitioning, organization, and interaction of the components and/or modules of the AI-based supplier management system (100) in FIG. 1 is intended to promote clear discussion and should not be considered fixed or limiting. For example, FIG. 1 depicts a requirements determination system (110) as an independent entity, however, it is well understood that in practice the requirements determination system (110) may be implemented as part of the user interface (170) (e.g., through a “front end” coding effort) or as part one or more AI models (e.g., through a “back end” coding effort).

In accordance with one or more embodiments, the AI-based supplier management system (100) includes a requirements determination system (110). The requirements determination system (110) is configured to accept a specification (105) from a user. The specification (105) describes one or more needs for a project of an organization. Non-limiting examples of the project include construction of a facility, support for a specified software product or software service, and acquisition of material goods. The specification (105) can be in various formats such as, but are not limited to: an email; a spreadsheet; a text file; a binary file; or combinations thereof. The requirements determination system (110) is configured to obtain a specification (105) and extract, using at least in part a first AI model (112), a set of requirements (“requirements”) (115). The requirements (115) include data for one or more services or products identified from the specification (105). The data includes, for each of the one or more services or products, a type of the service or product, a quantity of the service or product, and a delivery schedule. The delivery schedule of a first product or service may be dependent on the delivery schedule of a second product or service. For example, the requirements (115) may set forth that the first product or service is to be delivered after delivery of the second product or service, or vice versa.

In accordance with one or more embodiments, the extracted requirements (115) are produced, using the requirements determination system (110), according to a predefined format including an order of data and predetermined ranges or categorizations for data values. Thus, while the specification (105) can be of various formats and/or partition information in different orders, extracted requirements (115) for different projects are directly comparable. For example, the requirements (115) can include a determined class or category for a type of product or service where the class can be one of a predefined plurality of classes. The number of classes, their naming convention, and sub-classes can be defined according to the anticipated needs of an organization.

In accordance with one or more embodiments, the first AI model (112) includes at least one AI model selected from the group consisting of: a bidirectional encoder representations from transformers (BERT) model, a generative pre-trained transformer (GPT) model, and a sequence-to-sequence (seq2seq) model. In one or more embodiments, use of the first AI model (112), or more generally use of the requirements determination system (110), includes processing the specification (105) with a natural language processing method, e.g., as a pre-processing method before application of the first AI model (112).

The natural language processing method can include a parser and a vectorizer. The parser identifies words in the specification (105). Here, the words are not restricted to a single word but may be composed of multiple words. That is, parsed words may be a phrase. The identified words may further be parsed by the parser such that not all identified words are retained. For example, the parser may remove, or ignore, common words such as “the,” “and,” “that,” and “it” and the parser may remove punctuation. While these examples are given in the English language, the parser may be configured to interact according to the nuances of any written language. In some contexts, the parser may be referred to as a tokenizer. The parser may use any technique known in the art, such as white space tokenization, or the parser may make use of opens-source libraries such as spaCy, Gensim, NLTK, and TextBlob. The vectorizer can transform a parsed representation of the specification (105) into a numerical representation suitable for processing by an AI model, e.g., the first AI model (112). For example, the numerical representation of the parsed specification is a vector. One with ordinary skill in the art will appreciate that in many circumstances the functionality of the parser and vectorizer may be combined. Further, the identification of words, parsing, and vectorization may be performed by any technique known in the art without exceeding the scope of this disclosure. Natural language processing methods related to parsing and/or vectorization may include, but are not limited to: bag-of-words, n-grams, true frequency—inverse document frequency (TF-IDF), and embeddings. In accordance with one or more embodiments, these techniques may be combined. For example, the words may be extracted and parsed according to a white space tokenizer, and then adjacent pairs of words may be combined to form 2-grams. The 2-grams may be processed with an open-source word embedder, such as Word2Vec or FastText, to form a numerical value for each word, and the parsed words from the specification (105) may be compiled in a vector. These techniques may also include functionality to account for spelling errors, synonyms, capitalization, and language specific nuances such as contractions and punctuation. The vector representation of a specification may be further pre-processed, for example, through normalization.

Keeping with FIG. 1, the AI-based supplier management system (100) includes a database (160). The database (160) contains various partitions or tables of data and is accessible for read and/or write operations by various other components of the AI-based supplier management system (100) such as the requirements determination system (110). In one or more embodiments, the database (160) is a SQL-based repository. Further, in one or more embodiments, the database (160) is configured to filter, identify, and/or select data elements from the database (160) according to one or more filters and/or constraints such as a time validity constraint discussed later in the instant disclosure. The database (160) includes requirement data (169). The requirement data (169) includes the requirements (115) as determined by the requirements determination system (110) along with past or prior requirements related to other projects and as determined using the requirements determination system (110). Thus, the requirements determination system (110) can add, or aggregate or append the requirements (115) to the requirements data (169).

In accordance with one or more embodiments, the database (160) further includes supplier data (162), performance data (164), questionnaire response history (166), historical data (167), and market data (168). Supplier data includes information relating to one or more suppliers such as a unique supplier identifier, a supplier name, and one or more classes or categorizations that define the type of products and/or services offered by the supplier. Supplier data (162), for example relating to a new supplier, can be added to the database (160) using the supplier identification system (120) discussed below. The performance data (164) includes data, such as key performance indicators (KPIs), real-time performance and history thereof, for each supplier having supplied (or supplying) a product and/or service. That is, the performance data (164) includes a history of performance evaluations for a supplier that has provided (or is providing) a product and/or service for a project of the organization. The questionnaire response history (166) includes prior questionnaires, each including one or more queries, issued to one or more suppliers and the associated responses of the suppliers to each query. The historical data (167) includes details relating to the products and/or services supplied by a supplier such as type, quantity, and price. This data is referred to as “historical” data (167) because the details relating to the products and/or services provided by a supplier can exhibit a time-dependent behavior. That is, a first supplier may have provided a first product at a first price at a first time but then provided the same first product at a second price at a second time where the first time and first price are different from the second time and second price, respectively. In other words, supplier products and/or services and their associated costs can change with time and the historical record of exchanged, purchased, and/or supplied productions and/or services is contained by the historical data (167). Finally, the market data (168) includes present and historical data including the overall or aggregated (e.g., averaged) price of products and/or services having been previously supplied by one or more suppliers. As described below, an evaluation of a supplier can include a comparison of a parameter of a product and/or service (e.g., price) offered by the supplier to a market representation of that parameter.

Continuing with FIG. 1, the AI-based supplier management system (100) further includes a supplier identification system (120). The supplier identification system (120), as explained in greater detail later in the instant disclosure, is configured to provide one of at least three functions.

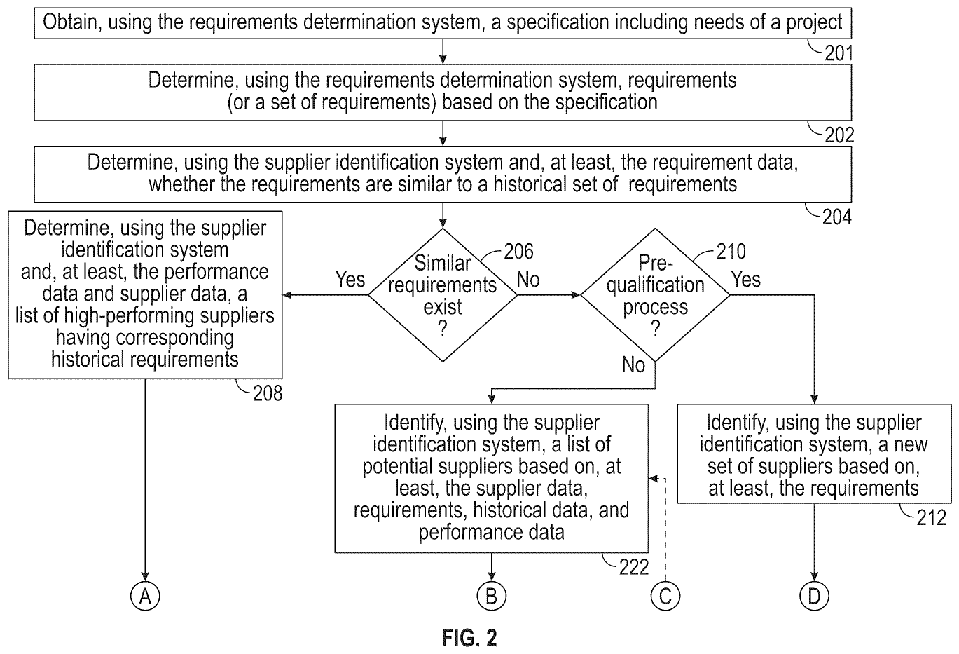

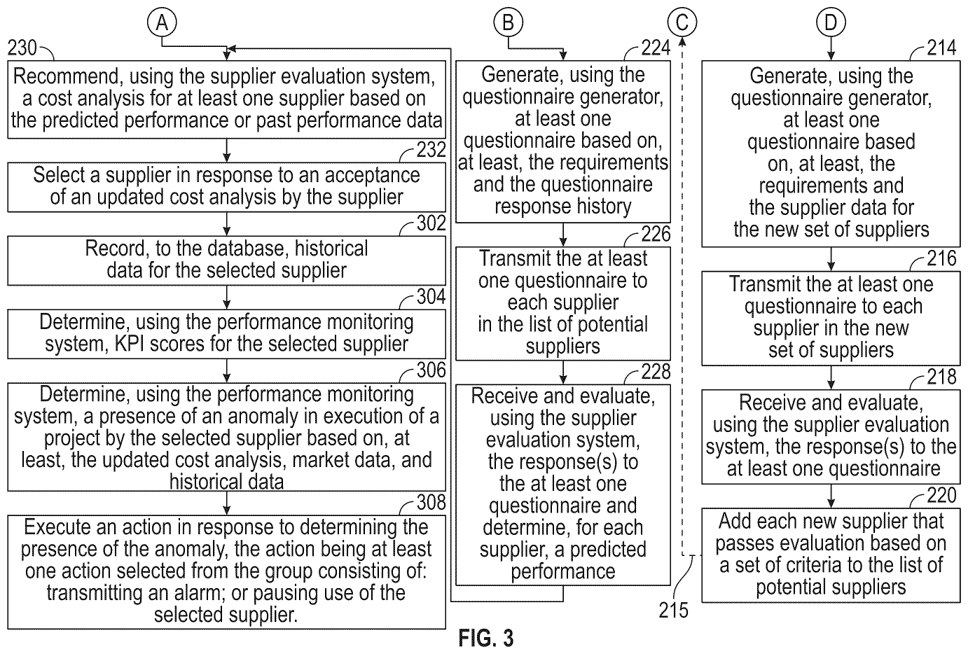

A first function that can be performed by the supplier identification system (120) is a similarity analysis (121). The similarity analysis (121) consists of determining a similarity metric for each combination of the requirements (115) and one or more historical requirements contained by the requirement data (169). In one or more embodiments, the similarity analysis (121) includes a clustering technique to identify whether any of the one or more historical requirements and the requirements (115) are similar by nature of being assigned to the same cluster (i.e., the similarity metric can be a binary categorization of “sharing” or “not sharing” a cluster assignment). In other embodiments, the similarity analysis (121) includes a determination of the distance between a vectorization of the requirements (115) or specification (105) (e.g., using the above described vectorizer) and a vectorization of each of the one or more historical requirements, where the distance can be, for example, any distance norm such as an L1 norm (“Manhattan norm”) or an L2 norm (“Euclidean norm”). In these embodiments, the requirements (115) and a historical requirements may be considered similar if the similarity metric exceeds a given similarity threshold. In other embodiments, the similarity analysis (121) makes use of an AI model such as a random forest to group or identify similarities between the requirements (115) and historical requirements and output a similarity metric. Again, a determination of similarity can be made through comparison of the similarity metric and a similarity threshold. As described below with reference to FIGS. 2 and 3, in some scenarios the supplier identification system (120) generates a list of potential suppliers (“supplier list” (125)) by identifying at least one potential supplier from the database (160) (i.e., with the supplier data (162)) associated with historical requirements (i.e., from the requirements data (169)) having sufficient similarity with the requirements (115) (e.g., through comparison of a similarity metric to a similarity threshold).

A second function that can be performed by the supplier identification system (120) is the discovery (or search for) a new set of suppliers (where the set can be empty or include one or more new suppliers). The second function is performed via a connection with a web interface (180) and a second AI model (122) included in the supplier identification system (120). In one or more embodiments, the supplier identification system (120) includes search and scraping capabilities of online systems (e.g., the internet) to identify new suppliers not in the database (160) (i.e., without existing supplier data (162)). In one or more embodiments, the second AI model (122) extracts supplier data (162) for a new supplier from information collected online about the supplier using the supplier identification system (120). Similar to the first AI model (112), the second AI model (122) can include, or make use of, natural language processing techniques to extract the supplier data (according to a predefined and consistent format) from a webpage, or other representation, of the new supplier.

A third function that can be performed by the supplier identification system (120) is the generation of the list of potential suppliers (“supplier list” (125)) by identifying at least one potential supplier from the database (160) (i.e., with the supplier data (162)) without the benefit of the requirements having similarity to historical requirements. In this scenario, the supplier identification system (120) generates the supplier list (125) based on, at least, the supplier data (162), requirements (115), performance data (164), and historical data (167). That is, the supplier identification system (120) generates the supplier list (125) through evaluation of the past performance and offered products and/or services of suppliers in the database (160) in view of the requirements (115). In one or more embodiments, the supplier list (125) is generated by the supplier identification system (120), by identifying at least one potential supplier that supplies the type of service or product included in the requirements (115) based on the supplier data (162). That is, a supplier in the database that provides the type or product or service specified in the requirements (115) is added to, or included in, the supplier list (125).

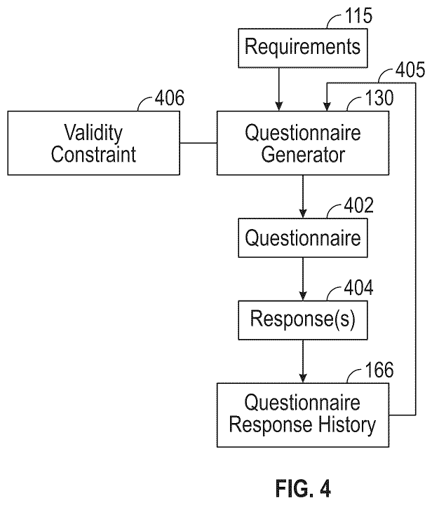

The AI-based supplier management system (100) further includes a questionnaire generator (130). The questionnaire generator (130) considers the supplier list (125), the requirements (115) and questionnaire response history (166) to generate a questionnaire including at least one query. The questionnaire is tailored based on the extracted requirements (115), and in view of the questionnaire response history (166), to ensure that the queries provided to potential suppliers (i.e., the supplier list (125)) are relevant (e.g., to the requirements (115)) and not redundant (e.g., having been asked before in a previous questionnaire to a supplier). In one or more embodiments, the questionnaire is generated using a third AI model (132) included in the questionnaire generator (130). In accordance with one or more embodiments, the third AI model is selected from the group of AI models consisting of: a transformer-based model, a generative pre-trained transformer model, or a knowledge graph. Further, in one or more embodiments, the questionnaire generator further includes, or is informed by, a predefined time validity (or time validity constraint). The predefined time validity is a time or duration that indicates an expiration of a response to a query (or questionnaire). For example, the predefined time validity may indicate that a query or response to a query that exceeds the predefined time validity is not to be considered by the questionnaire generator (130). For example, for some queries the predefined time validity may be a period of 1 year. Thus, the questionnaire response history (166) includes a timestamp for each query and associated response for each supplier. Notably, a query and/or associated response that exceeds the predefined time validity need not be removed or deleted from the questionnaire response history (166); but rather not considered by the questionnaire generator (130). In this way, a change in a supplier's response to a query can be evaluated over time. Because the questionnaire generator (130) does not take into consideration queries (or responses) that exceed the predefined time validity, these queries can be provided to the supplier(s) despite having been previously provided to the supplier(s). Thus, the predefined time validity indicates a period for which a supplier's response may be considered stale or in in need of updating and thus obtained anew through use of a recycled query (or questionnaire). As explained in greater detail with respect to FIG. 4, the questionnaire generator (130) has a feedback loop with the questionnaire response history (166) such that new queries are generated based on received responses. In some implementations, queries are generated sequentially based on suppliers' responses. For example, a first query is generated and response(s) for the first query are received and evaluated. Then, based on the received and evaluated responses, a second query is generated forming an ordered sequence of queries where each query is informed (or generated) based on the response(s) to prior queries in the sequence.

In one or more embodiments, the questionnaire generator (130) includes a chatbot configured to transmit queries to one or more suppliers and receive responses from the one or more suppliers. In one or more embodiments, the chatbot can directly receive and parse text, image, and audio data (e.g., using a user interface (170)). In some implementations, using natural language processing, the chatbot provides real voice to speech recognition in multiple languages. In some implementations, the chatbot, through the user interface (170) can scan in pictures (or other visual data) and use visual character and imaging software to interpret the scanned data.

In accordance with one or more implementations, input data in the form of a response to a query is obtained from a supplier through interaction with the chatbot. For concision, a brief description of a chatbot and its interactions with a supplier are provided herein. However, one with ordinary skill in the art will recognize that a chatbot may be implemented in a variety of ways such that the following description does not impose a limitation on the present disclosure. The input data obtained by the chatbot is composed of one or more input values. Often, input values are associated with a data type and range or set of acceptable values. For example, a given input value may be specified to represent a numeric value for a month, in which case the input value data type may be restricted to an integer data type and the acceptable range of the input value is set to the numbers 1 through 12.

In general, a chatbot has access to one or more queries, where each query is associated with one or more input values of the input data. In one or more embodiments, the relationship of queries and associated input values are defined by a set of query templates (131). The chatbot identifies an input value that should be received from the supplier and prompts the supplier with an appropriate query. The supplier responds to the a query with a response. The chatbot analyses the response and determines whether the desired input value(s) is contained in the response and further validates the input value(s) with a data validator. That is, the chatbot both identifies a candidate input value in the response of the supplier and determines if the candidate input value is valid based on the pre-defined data type and set of acceptable values, if provided in the set of query templates (131). In many instances, the data validator used by the chatbot is configured with one or more data preprocessing and parsing algorithms (e.g., stemming, regular expressions, etc.) and/or natural language processing models to properly handle text variations (e.g., capitalization), provide common mappings (e.g., month abbreviations to numeric values), and allow for data type coercion (e.g., floats to integers).

Based on the analysis of a response, the chatbot can accept the input value or re-prompt the supplier. If the chatbot determines that a supplier should be re-prompted for an input value, the chatbot may re-use the query or propose a new query and/or provide aid or suggestions to the supplier, for example, detailing why the original response and input value(s) were not accepted. If an input value(s) is accepted by the chatbot, the chatbot may provide the supplier with another query to obtain other input values. Note that in some instances, subsequent queries selected by the chatbot are determined based on previously received input values as previously described with respect to the questionnaire generator (130). The chatbot may continue prompting the supplier with selected queries until the required input data has been received. The scope of the required input data may be altered according to the input value(s) received from the supplier. That is, based on received input value(s) the chatbot may determine that other input values are no longer required and thus does not prompt the supplier with the associated queries. Again, it is emphasized that the above description of a chatbot does not impose a limitation on the instant disclosure as various types of chatbots may be readily inserted into the framework disclosed herein. In some implementations, the questionnaire generator (130) and the chatbot are one and the same, where, for example, a questionnaire including a plurality of queries is formed and transmitted to one or more suppliers and there is not a direct connection or communication interface between the one or more suppliers and the chatbot.

In accordance with one or more embodiments, the chatbot and/or questionnaire generator (130), through interactions with suppliers and recorded in the form of questionnaire response history (166), is configured to intelligently adapt its queries to efficiently extract relevant information from the supplier in view of the requirements (115). The questionnaire generator (130) is not restricted to a pre-defined set of queries. The chatbot and/or questionnaire generator (130) evaluates its interactions (i.e., queries and responses) with suppliers and based on the evaluation, can select different queries, alter existing queries, and/or generate queries to more efficiently extract desired information (input values) from the suppliers while simultaneously enhancing supplier experience.

Keeping with FIG. 1, the AI-based supplier management system (100) further includes a supplier evaluation system (140). The supplier evaluation system (140) determines a set of criteria (141) for evaluating suppliers (e.g., from the supplier list (125)) based on the requirements (115). In some implementations, determination of criteria (141) is executed alongside, or in direct response to, a generate query and/or questionnaire. For example, a query regarding a price per unit of a product, or tiered pricing of a product based on quantity tiers, can be associated with a price criterion. Other criteria (141) can include, but are not limited to, measures of quality, delivery time, financial stability, and sustainability. Thus, the criteria (141) provide metrics or measurements for evaluating and comparing one or more suppliers. Values for the criteria are determined based on the responses to the questionnaire(s) provided to each supplier under evaluation. In some implementations, the criteria values are aggregated to form a feature vector for each supplier and the feature vector is used as an input to a fourth AI model (142) that determines a predicted performance (144) for each supplier. Thus, the fourth AI model (142) can provide a weighting for combing and jointly considering the criteria values to directly compare suppliers using the predicted performance (144), where, under this viewpoint the predicted performance (144) can be considered a composite score based on the criteria values. The fourth AI model (142) can be an AI model selected from the group consisting of: support vector machine, decision tree, random forest, and neural network. In one or more embodiments, the predicted performance (144) includes a qualitative (e.g., a category such as “underperforming,” “acceptable,” and “exceptional”) and/or a quantitative (e.g., a score from 0 to 100) indicative of a supplier's ability to supply a product and/service according to the requirements (115).

In one or more implementations, the supplier evaluation system (140) further makes a recommendation for each evaluated supplier (recommendations (146)). A recommendation for a supplier can include a cost analysis (135) where the cost analysis (135) includes one or more proposed terms (e.g., cost of a product or service, delivery schedule, etc.) tailored to each supplier. In some embodiments, the cost analysis (135) is used to guide negotiations or further execute a contract between the organization and a supplier to provide one or more products or services as set forth in the recommendation. In one or more embodiments, the recommendations (146) include consideration of market data (168) and performance data (164), where these provide indicators of current expected prices across suppliers and the past performance of the considered supplier, respectively.

In accordance with one or more embodiments, the supplier evaluation system (140) selects, or outputs, a selected supplier (145) based on the predicted performance (144) of each evaluated supplier (e.g., from the supplier list (125)). In one or more embodiments, the selected supplier (145) is the supplier from the supplier list (125) with the highest, or best, predicted performance (144).

In one or more embodiments, the AI-based supplier management system (100) further includes a performance monitoring system (150). Upon selection of a supplier (i.e., selected supplier (145)) and establishment of a contractual obligation between the selected supplier (145) and the organization, the selected supplier (145) begins supplying one or more products or services to the organization. The performance monitoring system (150) monitors the selected supplier (145), determines a real-time performance of the selected supplier (145), and records that real-time performance data in the performance data (164) of the database (160) and further records all transfers of products and/or services and associated payments and delivery times in the historical data (167) of the database (160). Thus, this information is considered when identifying and evaluating the selected supplier (145) for other projects (i.e., other requirements (115)).

In one or more embodiments, the performance monitoring system (150) defines key performance indicators (KPIs) (151). The KPIs provide a measure (quantitative or qualitative) of the performance of the selected supplier (145) in providing the agreed upon products and/or services (e.g., according to a given price and/or delivery schedule). Example KPIs can include the percentage or ratio of on-time deliveries, average deviation of price, average delay time for late products and/or services, etc. As such, each KPI can be scored. The performance monitoring system (150) tracks and records the KPI scores (151). In one or more embodiments, the real-time performance of the selected supplier (145) includes the current, or most up-to-date, KPI scores (151).

Further, in one or more embodiments, the performance monitoring system (150) identifies KPIs (or KPI scores) (151) with poor performance using one or more anomaly and/or outlier detection algorithms encompassed by a fifth AI model (152). In one or more embodiments, the fifth AI model (152) is selected from the group of AI models consisting of: an ARIMA time series analysis, long short-term memory recurrent neural network, and a reinforcement learning model. In one or more embodiments, outliner and anomaly detection ranges are dynamic and can vary with time. That is, the performance monitoring system (150) can efficiently track transient and non-stationary signals. In most cases, the expected result and/or range is based on historic trends (e.g., from the historical data (167) and market data (168)) over a specified time period. The performance monitoring system (150) operates by comparing the current value for the KPI to the expected range and/or result. This comparison factors in previous trends and considers seasonality.

In one or more embodiments, the performance monitoring system (150) searches for anomalies on a monthly basis and will only search for anomalies when presented with at least 3 months of data. In one or more embodiments, outliers are determined by comparison of the KPI value to a moving average. In one or more embodiments, a KPI score (151) is determined to be an outlier if it resides outside the interquartile range (IQR) for the KPI, historically. In one or more embodiments, outliers are also detected using shorter time periods. For example, time periods such as 2 days, 2 weeks or 2 months may be used. Thus, the performance monitoring system (150) can identify outliers and/or anomalies over multiple time scales. An example of an anomaly may be a sudden increase in decrease of a price of a product or service supplied by the selected supplier (145) (e.g., through evaluation of an invoice or payment disbursement).

In addition to identifying outliers and/or anomalies, the performance monitoring system (150) can determine the root cause of a detected issue. In one or more embodiments, upon detecting an outlier/anomaly, the performance monitoring system (150) performs a root cause analysis. The root cause analysis determines the factors that resulted in the outlier/anomaly. In one or more embodiments, the root cause analysis evaluates changes in recorded data metrics over various data segments. Data segments may include type of product or service, season, a measurement of market sentiment, etc. In one or more embodiments, the performance monitoring system (150) can alter (or adapt) a delivery schedule, quantity, or proposed price for a product and/or service according to the detected outliers/anomalies and the root cause analysis. In other words, the performance monitoring system (150) can propose interventions and actions to reduce risk and bring a supply of a product and/or service back on track.

The performance monitoring system (150) further provides report generation (154) and alarm (153) functionalities. Alarms (153) simply refer to alerting one or more users if an issue is detected (e.g., anomaly) and/or if an alteration to a supply of a product or service is proposed or recommended. Alarms (153) may take the form of email and SMS notifications. The performance monitoring system (150) also generates a detailed report (154) describing the identified issue, underlying analysis, and recommendation in greater detail. The report may be displayed to the user through a user interface (170), made available to download through a link, and/or distributed to one or more users via email.

In accordance with one or more embodiments, the AI-based supplier management system (100) further includes a user interface (170) for interaction between a user and one or more components of the AI-based supplier management system (100). To avoid cluttering FIG. 1, the user interface (170) is only depicted as being connected to the database (160), however, in practice the user interface can communicate with, or be implemented as part of, any of the above-described systems (e.g., requirements determination system (110), performance monitoring system (150)) without limitation. In one or more embodiments, the user interface (170) is a graphical user interface. The user interface (170) acts as the point of human-computer interaction and communication. Thus, the user interface (170) can receive inputs from a user such as the specification (105). The user interface (170) can further provide visualizations, such as graphs, reports (e.g., reports from report generation (154)), and text and image data, to one or more users. In broad terms, the user interface (170) can include display screens, keyboards, and a computer mouse. In one or more embodiments, the user interface (170) is implemented as a computer program, such as a native application or a web application.

FIGS. 2 and 3 depict a flowchart detailing the use of the AI-based supplier management system (100) in accordance with one or more embodiments. In particular, FIGS. 2 and 3 demonstrate how the AI-based supplier management system (100) can be used in various scenarios including, for example, a pre-qualification process to identify new potential suppliers and a condensed supplier identification process in instances where the extracted/determined requirements (115) are similar to a prior set of requirements (i.e., historical requirements).

The flowchart begins in Block 201 of FIG. 2 by obtaining a specification (105) from a user of the AI-based supplier management system (100). The specification (105) can be obtained using the user interface (170) and the requirements determination system (110). In Block 202, requirements (115) corresponding to the specification (105) are determined using the requirements determination system (110) as previously described. In Block 204, the supplier identification system (120) is used to determine whether there is a historical set of requirements (from the requirement data (169) of the database (160)) with similarity to the requirements (115). That is, the first function of the supplier identification system (120) is executed including the similarity analysis (121).

Block 206 represents a decision where one of two paths is selected based on whether there is similarity between the requirements (115) and at least one historical set of requirements. If, in Block 206 it is determined that a historical set of requirements has sufficient similarity to the requirements (115) (e.g., a historical set of requirements has a similarity metric that satisfies a similarity threshold), then the flowchart of FIGS. 2 and 3 proceeds to Block 208. Otherwise, if it is determined that similar requirements do not exist in the requirement data (169) then the flowchart of FIGS. 2 and 3 proceeds to Block 210.

In Block 208, the supplier identification system (120) considers all suppliers with a corresponding historical set of requirements. The supplier identification system (120) generates a supplier list (125) based on these suppliers and further in view of performance data (164) of these suppliers. Because these suppliers have supplied products and/or services for a project with similar requirements has the requirements (115) of the current project (or project under evaluation by the AI-based supplier management system) and are further evaluated based on their past performance (i.e., performance data (164)), it is said that the produced supplier list (125) consists of the high-performing suppliers having corresponding historical requirements.

Returning to Block 210, Block 210 also represents a decision where it is determined whether a pre-qualification process is being performed. Pre-qualification, in general, refers to the discovery of new potential suppliers as well as an initial evaluation of these new suppliers. For example, new potential suppliers that pass pre-qualification can be added to the supplier data (162) in the database and considered for selection when performing a technical evaluation. If the process is not a pre-qualification process, the process is said to be a technical evaluation. In a technical evaluation, and as will be described in the following paragraphs, one or more suppliers are selected to supply one ore more goods or services according to the needs of the project. When using the AI-based supplier management system (100) with a project, or proposed project, of an organization, the user can indicate whether a pre-qualification process should be executed. If the process, as determined in Block 210, is, or includes, a pre-qualification process, the flowchart of FIGS. 2 and 3 proceeds to Block 212. If the process does not include a pre-qualification process or if the pre-qualification process has already been performed (see connection 215), the flowchart of FIGS. 2 and 3 proceeds to Block 222.

In Block 212, the supplier identification system (120) is used to identify a new set of suppliers based on, at least, the requirements (115). That is, the second function of the supplier identification system (120) is executed including supplier discovery using the web interface (180). Supplier discovery includes inspection of profiles (e.g., web pages) of potential suppliers not already listed in the database (160) (i.e., having supplier data (162)) to determine whether the supplier can possibly provide one or more products and/or services as identifying (e.g., by type, price, and delivery schedule) in the requirements (115). Supplier data (162) is added to the database (160) for each new supplier in the new set of suppliers. In Block 214, the questionnaire generator (130) is used to generate at least one questionnaire based on, at least, the requirements (115) and the supplier data (162) for the new set of suppliers. For pre-qualification, the questionnaire can consist of introductory or validation-type queries to determine the accuracy of the supplier data (162) for this new set of suppliers (e.g., to determine whether a new supplier can actually provide a specified product or service or if the supplier should be removed from the database (160) or otherwise annotated or updated to indicate the status of the newly identified supplier). In Block 216, the at least one questionnaire is transmitted to each supplier in the new set of suppliers. Transmission can occur, for example, through automatic generation and transmission of an email. In Block 218, responses(s) to the at least one questionnaire that was sent to each supplier in the new set of suppliers is received and evaluated using the supplier evaluation system (140). The supplier evaluation system (140) can determine one or more KPIs and a predicted performance for each supplier in the new set of suppliers. A supplier in the new set of suppliers may be said to “pass” the pre-qualification process if the predicted performance and/or one or more KPIs satisfies a pre-qualification standard. The pre-qualification standard can be a relaxed performance threshold. In Block 220, each new supplier that passed the evaluation is added to a list a potential suppliers developed in Block 222. Thus, the connection 215 is depicted with a dashed arrow to indicate that the output of Block 220 (i.e., new suppliers that passed a pre-qualification evaluation) integrates with a supplier list (i.e., list of potential suppliers) of Block 222.

Block 222 is the entry point of the flowchart of FIGS. 2 and 3 for the technical evaluation process. Thus, Block 222 can be executed after Block 210 in response to determining that the process is not a pre-qualification process or after having executed a pre-qualification process (i.e., Blocks 212, 214, 216, 218, 220). In Block 222, the supplier identification system (120) is used to identify or generate a list of potential suppliers based on, at least, the supplier data (162), the requirements (115), historical data (167), and performance data (164). That is, in Block 222, the third function of the supplier identification system (120) is executed to produce a list of potential suppliers (e.g., supplier list (125)) through evaluation of previously used suppliers without the benefit of having similar historical requirements. As discussed, in some implementations, new suppliers having passed the pre-qualification evaluation are appended to the list of potential suppliers. In Block 224, the questionnaire generator (130) is used to generate at least one questionnaire based on, at least, the requirements (115) and the questionnaire response history (166). Thus, for the technical evaluation, the at least one questionnaire is generated in consideration with prior queries and associated responses given to and received from suppliers included in the list of potential suppliers. In one or more embodiments, the questionnaire generator (130) does not take into consideration queries and/or associated responses if they exceed a time validity constraint (e.g., a 1 year expiration). Notably, the at least one questionnaire of Block 224 is distinct from the at least one questionnaire of Block 214 because in Block 214 there is no questionnaire response history for the suppliers in the set of new suppliers. That is, the at least one questionnaire for the pre-qualification process is different from the at least one questionnaire for the technical evaluation. In other words, the AI-based supplier management system (100) can generate both a pre-qualification questionnaire (or at least one questionnaire of this type) and a technical evaluation questionnaire (or at least one questionnaire of this type). In Block 226, the at least one questionnaire (technical questionnaire) is transmitted to each supplier in the list of potential suppliers. Again, the transmission can include the automatic generation and transmission of an email including the questionnaire and/or a link, for example, to connect to the questionnaire and/or a chatbot. In Block 228, the supplier evaluation system is used to receive and evaluate the response(s) to the at least one questionnaire and to determine, for each supplier in the list of potential suppliers, a predicted performance (144).

In Block 230, either a list of potential suppliers and associated predicted performances (144) or a list of high-performing supplies having similar historical requirements is available. In Block 230, the supplier evaluation system (140) is used to generate a cost analysis (135) for at least one supplier of the provided list based on the predicted performance (144) or past performance data (164); depending on whether the list originates from Block 228 or Block 208, respectively. For example, the supplier from the list of potential suppliers (Block 228) with the highest predicted performance (144) can be recommended, along with an associated cost analysis (135), to the be selected supplier (245). In Block 232, a supplier is selected as the selected supplier in response to an acceptance of an updated cost analysis by the given supplier. The updated cost analysis can include changes, if any, to the cost analysis (135) as long as the proposed changes are accepted by both the given supplier and the organization. Thus, negotiation of terms outlined in the cost analysis (135) can occur between Block 230 and Block 232.

In one or more embodiments the flowchart of FIGS. 2 and 3 terminates after execution of Block 232. In other embodiments, the flowchart of FIGS. 2 and 3 continues to include performance monitoring steps outlined in Blocks 302, 304, 306, and 308; described below.

In Block 302 historical data (167) for the selected supplier (145) is continuously recorded and stored in the database (160) as acquired. The historical data (167) can include details regarding the actual supply of one or more products or services by the selected supplier (245) to the organization including products/services received, their price, and their delivery date. In Block 304, the performance monitoring system (150) is used to determine KPI scores (151) for the selected supplier (245). An example KPI can relate to supplier timeliness and have a score of the percentage of on-time deliveries. In Block 306, the performance monitoring system (150) is used to determine a presence of an anomaly in execution of the project ty the selected supplier (245). The presence and type and/or severity of the anomaly can be determined using the updated cost analysis, market data (168), and historical data (167) (i.e., the historical data or project history for the project in view of the updated cost analysis). In Block 308, an action is executed in response to determining the presence of the anomaly. The action can include transmitting an alarm (153), pausing use of the selected supplier (245), or combinations thereof. Pausing use of the selected supplier (245) can include temporarily halting the supply of products or services by the supplier pending a manual review of the supplier's performance by a subject matter expert or user of the AI-based supplier management system (100).

FIG. 4 depicts a feedback loop of the questionnaire generator (130) in accordance with one or more embodiments. In one or more implementations (e.g., when executing a technical evaluation) the questionnaire generator (130) generates a questionnaire including one or more queries using the questionnaire response history (166). The questionnaire response history (166) includes all prior queries and associated responses asked of, and received from, suppliers. As seen in FIG. 4, the questionnaire generator (130) generates a questionnaire (402) (or, at least one query) based on (at least initially) the requirements. The questionnaire (402) is transmitted to a supplier and the supplier provides a response (404). The questionnaire (402) and response (404) are added to the questionnaire response history (166). Then, through the feedback loop (405), the questionnaire generator (130) uses both the requirements (115) and questionnaire response history (166) to generate a new questionnaire (402). In this manner, the questionnaire (402) is tailored to the supplier (in view of both the requirements (115) and the questionnaire response history (166)) ensuring that the supplier does not receive duplicate or redundant queries and that the queries (or questionnaires) extract useful and relevant information from the supplier. Further, as seen in FIG. 4 and in accordance with one or more embodiments, the questionnaire generator (130) can be configured using one or more validity constraints (406). An example validity constraint (406) is a time validity constraint or a predefined time validity. The time validity constraint can define an expiration period for a query and/or associated response. For example, a response from a supplier regarding a price of a product can be considered invalid after a specified time. Thus, the time validity constraint can serve to preserve both the history of queries and responses in the questionnaire response history (166) and allow the questionnaire generator (130) to re-query a supplier for information as needed over time. Another example of a validity constraint (406) that can be applied alongside, or independent from, the time validity constraint is a resource validity constraint. The resource validity constraint may be imposed to ensure that potential suppliers have one or more resources identified as required (e.g., in the requirements (115)) to support the project. An example of a resource can be a number of qualified personnel available to provide or enact a service. The resource validity constraint can inform the questionnaire generator (130) to generate one or more queries (as part of a questionnaire) to validate the availability of one or more resources by the supplier. Further, the resource validity constraint can command the questionnaire generator (130) to generate these one or more queries for each project regardless of whether a supplier has responded to a similar query in the past (e.g., from a prior project and associated questionnaire stored in the questionnaire response history (166)).

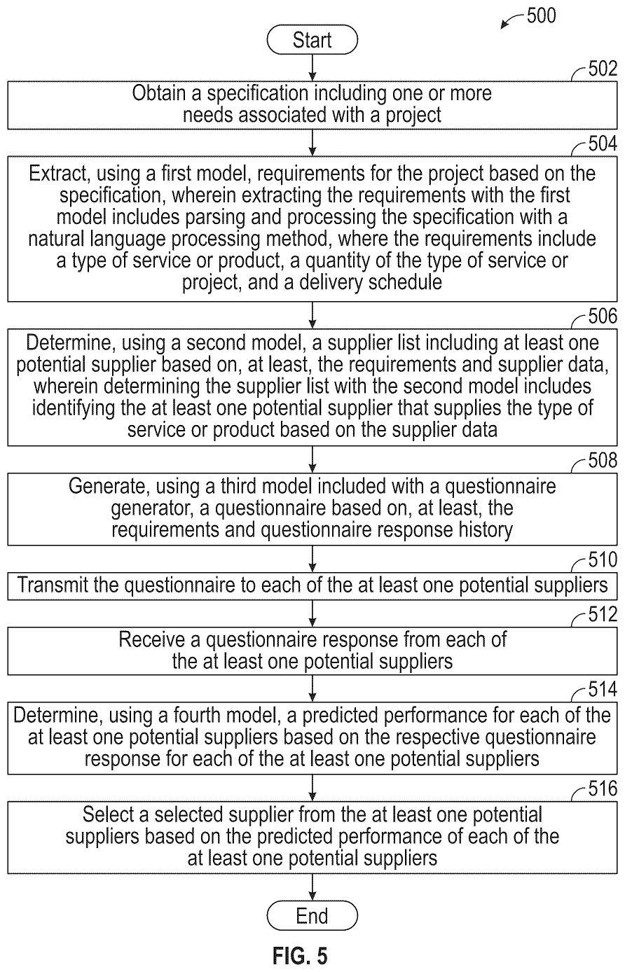

FIG. 5 depicts a method (500) in accordance with one or more embodiments. The method of FIG. 5 includes one or more steps that are performed by, or using, the AI-based supplier management system (100) as described above. While the various steps in the method (500) are presented and described sequentially, one of ordinary skill in the art will appreciate that some or all of the steps may be executed in different orders, may be combined or omitted, and some or all of the steps may be executed in parallel. Furthermore, the steps may be performed actively or passively.

In Step 502, a specification including one or more needs associated with a project is obtained. In Step 504, a first model (e.g., first AI model (112) of the requirements determination system (110)) is used to extract requirements for the project based on the specification, where extracting the requirements with the first model includes parsing and processing the specification with a natural language processing method. The requirements include a type of service or product, a quantity of the type of service or project, and a delivery schedule. In Step 506, a second model (e.g., second AI model (122) of the supplier identification system (120)) is used to determine a supplier list including at least one potential supplier based on, at least, the requirements and supplier data. Determining the supplier list with the second model includes identifying the at least one potential supplier that supplies the type of service or product based on the supplier data. That is, the supplier data includes the type(s) of service(s) and/or product(s) provided by one or more suppliers and only suppliers capable to providing the type of service or product specified by the requirements are included in the supplier list. In some implementations, Step 506 can further include querying, using a web interface, an online system (e.g., internet, web pages, search engine, etc.) to generate a list of new potential suppliers based on the requirements and aggregating data (or appending) for each new potential supplier of the list of new potential suppliers to the supplier data. In some implementations, Step 506 can further include determining a similarity metric between the requirements and historical requirements included in historical data, where the historical requirements are associated with a first potential supplier. These implementations can further include adding or including the first potential supplier in the supplier list in response to the similarity metric exceeding a similarity threshold.

In Step 508, a third model (e.g., third AI model (132)) included with a questionnaire generator is used to generate a questionnaire based on, at least, the requirements and questionnaire response history. The questionnaire includes one or more queries. In one or more implementations the questionnaire is generated in consideration of whether a past query included in the questionnaire response history exceeds a predefined time validity. In these cases, any past query that exceeds the predefined time validity is removed from consideration by the questionnaire generator. In one or more implementations, the questionnaire does not include (or excludes) past queries included in the questionnaire response history.

In Step 510, the questionnaire is transmitted to each of the at least one potential suppliers and in Step 512, a questionnaire response is received from each of the at least one potential suppliers. In some implementations, a questionnaire response can be considered null (e.g., a null value) or empty if another response to not received from a supplier within a predefined response period. That is, in the event that a questionnaire is not received from a supplier, the questionnaire can be considered received as empty or null. A such, it may be said that a questionnaire response is received from each of the at least one potential suppliers.

In Step 514, a fourth model (e.g., fourth AI model (142) included in the supplier evaluation system (140)) is used to determine a predicted performance for each of the at least one potential suppliers based on the respective questionnaire response for each of the at least one potential suppliers. In some implementations, a set of criteria for evaluating a questionnaire response from each of the at least one potential suppliers is also determined. The set of criteria can include, or define, one or more KPIs. Thus, the determined predicted performance for each of the at least one potential suppliers can be based on the set of criteria and/or KPIs.

In Step 516, a selected supplier is selected from the at least one potential suppliers based on the predicted performance of each of the at least one potential suppliers. In one or more implementations, Step 516 further includes recommending a cost analysis for the selected supplier based on the requirements and market data. Further, once selected a real-time performance for the selected supplier can be determined and recorded a performance data. Moreover, an alarm can be generated in response to the real-time performance being below a performance threshold. Performance monitoring of the selected supplier can be performed using a fifth model (e.g., fifth AI model (152) of the performance monitoring system (150)).

In review, a significant and time-consuming aspect of procurement is identifying and selecting qualified suppliers. The AI-based supplier management system (100) disclosed herein manage suppliers by automating pre-qualification and technical evaluation questionnaires along with their evaluating criteria. Then, via feedback loop, the questionnaires are enhanced and qualified suppliers are better identified. The AI-based supplier management system (100) makes use of various independent, but connected, AI models each with a specific task.

Processes of the AI-based supplier management system (100) begin with user input in the form of a specification that is analyzed by an automated requirements determination system to determine a set of requirements relating to a project (project needs). Based on the requirements, the processes branch into two parts depending on whether similar requirements exist. In the event that similar requirements exist (in the form a prior or historical set of requirements having similarity (according to a similarity metric)), the process identifies high-performing suppliers (or those that, through past projects, have demonstrated a capability to supplying the products and/or services outlined in the requirements). In the event that similar requirements have not been previously observed, the process further splits into two parts depending on whether a pre-qualification process is desired or a technical evaluation can be performed. In the event of a pre-qualification process, a set of new potential suppliers is identified/discovered using a web interface and a pre-qualification questionnaire is generated and distributed to each supplier in the new set of suppliers. A pre-qualification evaluation is performed on these suppliers based on their responses to the pre-qualification questionnaire and suitable suppliers (i.e., those that pass the pre-qualification evaluation) are added to a list of suppliers for a subsequent technical evaluation. In the event of a technical evaluation, a list of potential suppliers is developed using historical data, supplier data, and performance data contained in an existing database. The list of potential suppliers can include newly identified suppliers having passed pre-qualification. Then, a technical evaluation questionnaire is generated and distributed to each supplier in the list of potential suppliers. Generation of the technical evaluation questionnaire includes consideration of past responses of the suppliers in the list of potential suppliers given in response to to previous questionnaires and/or queries. The questionnaire responses are evaluated and, in some instances, follow-up questionnaires are generated based on the responses to determine a predicted performance for each supplier. The predicted performance can include, or be based on, various criteria and/or KPIs that measure or provide a metric of each supplier's ability to supply the products and/or services specified by the requirements. Performance of a selected supplier can be monitored and added to the database for use in future evaluations as the selected supplier supplies one or more products and/or services.

The streamlined processes enabled by the AI-based supplier management system (100) ensure that both recurring and new requirements are handled efficiently, with the system adapting to the specifics of each case. And importantly, the system uses a feedback loop with the questionnaire generator to ensure continuous improvement and efficient interaction with suppliers.

One or more embodiments disclosed herein provide several advantages described as follows. The AI-based supplier management system (100) automates the generation of dynamic, up-to-date, and customized questionnaires based on the specific scope of formalized and uniform requirements. The requirements can include, but are not limited to, safety standards, relevant work experience, execution strategy, work schedule, and manpower capabilities. The AI-based supplier management system (100) applies to both service and material sourcing, excluding price and delivery for non-manufacturing providers. The system automates technical creations and evaluations processes and supplier management. Further, the system incorporates a feedback loop that updates the database based on changes in the market, scope of awarded contracts, and supplier performance. The feedback loop used in questionnaire generation enables two key improvements: 1) efficiency in requalification; and 2) enhanced risk and workload evaluation. For 1), efficiency in requalification, for pre-qualifying a supplier in different services, the AI-based supplier management system (100) customizes queries based on existing data, reducing redundancy. For 2), enhanced risk and workload evaluation, the AI-based supplier management system (100) integrates risk levels and workload factors into the selection process. Additional advantages include the use of terms of agreement being stored as historical data that is then used to monitor the performance of suppliers, validate the accuracy of their response to questionnaires, and evaluate future responses by other suppliers. Another advantage is that based on the historical data, the AI-based supplier management system (100) can recommend contract terms (e.g., cost analysis) where products and/or services dictated by a set of requirements are distributed between one or more suppliers. That is, a first service and a second service can each be provided by a first and a second supplier. However, the AI-based supplier management system (100) can determine that the first supplier should only be used to supply the first service and the second supplier should only be used to supply the second service. As another example, a first supplier may bundle a first and second service together but the performance data can indicate poor performance on the second service (e.g., due to subcontracting) such that the second service should not be provided by the first supplier.

Consider the scenario in which the AI-based supplier management system (100), as described herein, has been applied to an organization's procurement unit. The procurement unit includes 9 personnel for managing a complex portfolio of sourcing activities. The portfolio management and sourcing activities include periodic pre-qualification evaluation and revalidation of 45 distinct supplier lists; a critical process undertaken every two years. Further, the procurement unit conduct rigorous project-based pre-qualification and technical evaluations, averaging approximately 250 evaluations annually. An observed improvement provided by the AI-based supplier management system (100) in the procurement unit is improved precision and reduced redundancy. Previously, manual processes resulted in repeated questions and non-unique questionnaires. In contrast, the AI-based supplier management system (100) eliminates redundancies by cross-referencing available response and avoiding repetitive content, thus improving the respondent's (i.e., supplier's) experience and accelerating the overall process. The system also avoids human errors, ensuring pre-qualification and technical evaluations are comprehensive and aligned with industry standards. Implementation of the AI-based supplier management system (100) in the stated procurement unit, based on initial estimates, is expected to result in cost savings of approximately $5 MM annually.

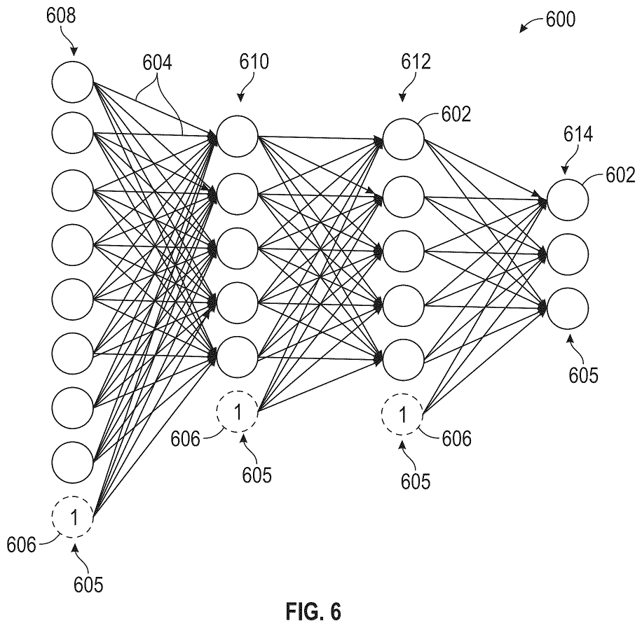

As an example of an AI model that may be included in, or used by, the AI-based supplier management system (100), FIG. 6 depicts a diagram of a neural network. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer.” A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (602) and edges (604) and ƒ is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Training data is provided to the neural network (600). Generally, training data consists of pairs of inputs and associated targets. The targets represent the “ground truth,” or the otherwise desired output, upon processing the inputs. In the context of the instant disclosure, for example with reference to the first AI model (112), an input can be a specification and its associated target is a set of requirements. Thus, in this example, the first AI model (112) is trained to extract a set of requirements from a specification.

During training, the neural network (600) processes at least one input from the training data and produces at least one output. Each neural network (600) output is compared to its associated input data target. The comparison of the neural network (600) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target. The loss function may also be constructed to impose additional constraints on the values assumed by the edges (604), for example, by adding a penalty term, which may be physics-based, or a regularization term (not be confused with regularization of seismic data). Generally, the goal of a training procedure is to alter the edge (604) values to promote similarity between the neural network (600) output and associated target over the training data. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

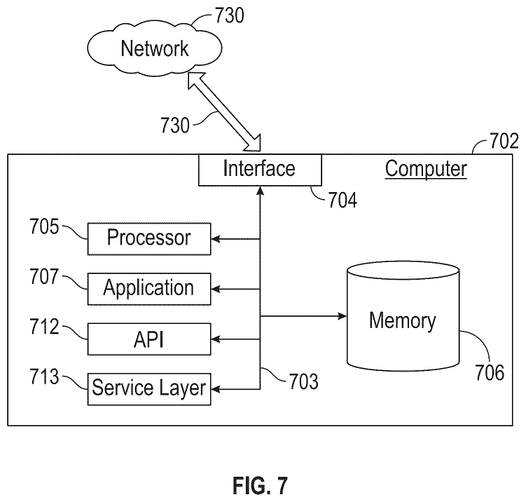

FIG. 7 further depicts a block diagram of a computer system (702) (e.g., the pressure control system) used to provide computational functionalities associated with the methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). The memory may be a non-transitory computer readable medium. For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a specification comprising one or more needs associated with a project;
extracting, using a first model, requirements for the project based on the specification, wherein extracting the requirements with the first model comprises parsing and processing the specification with a natural language processing method, wherein the requirements comprise a type of service or product, a quantity of the type of service or project, and a delivery schedule;
determining, using a second model, a supplier list comprising at least one potential supplier based on, at least, the requirements and supplier data, wherein determining the supplier list with the second model comprises identifying the at least one potential supplier that supplies the type of service or product based on the supplier data;
generating, using a third model comprised by a questionnaire generator, a questionnaire based on, at least, the requirements and questionnaire response history;
transmitting the questionnaire to each of the at least one potential suppliers;
receiving a questionnaire response from each of the at least one potential suppliers;
determining, using a fourth model, a predicted performance for each of the at least one potential suppliers based on the respective questionnaire response for each of the at least one potential suppliers; and
selecting a selected supplier from the at least one potential suppliers based on the predicted performance of each of the at least one potential suppliers.

2. The method of claim 1, wherein:
the questionnaire comprises one or more queries, and
generating, using the questionnaire generator, the questionnaire comprises:
determining whether a past query comprised by the questionnaire response history exceeds a predefined time validity, and
removing the past query from consideration by the questionnaire generator in response to the past query exceeding the predefined time validity.

3. The method of claim 1, wherein:
the questionnaire comprises one or more queries;
none of the one or more queries duplicate a past query comprised by the questionnaire response history.

4. The method of claim 1, further comprising:
determining a similarity metric between the requirements and historical requirements comprised by historical data, wherein the historical requirements are associated with a first potential supplier,
wherein determining the supplier list further comprises including the first potential supplier in the supplier list in response to the similarity metric exceeding a similarity threshold.

5. The method of claim 1, further comprising:
querying, using a web interface, an online system to generate a list of new potential suppliers based on the requirements; and
aggregating data for each new potential supplier of the list of new potential suppliers to the supplier data.

6. The method of claim 1, further comprising:
recommending a cost analysis for the selected supplier based on the requirements and market data.

7. The method of claim 1, further comprising:
determining, based on the requirements and the questionnaire, a set of criteria for evaluating a questionnaire response from each of the at least one potential suppliers.

8. The method of claim 7, wherein the determined predicted performance for each of the at least one potential suppliers is based on the set of criteria.

9. The method of claim 1, further comprising:
determining a real-time performance for the selected supplier; and
generating an alarm in response to the real-time performance being below a performance threshold.

10. The method of claim 1, wherein:
the questionnaire generator comprises a chatbot configured to receive and transmit data from and to each of the at least one potential suppliers,
the questionnaire comprises a sequence of queries and any subsequent query in the sequence of queries is determined, using the chatbot, based on one or more responses to prior queries in the sequence of queries.

11. An AI-based supplier management system, comprising:
a user interface;
a database comprising supplier data, historical data, market data, and questionnaire response history;
a requirements determination system configured to obtain, using the user interface, a specification and determine, using a first AI model comprised by the requirements determination system, requirements for a project based on the specification, wherein the requirements comprise a type of service or product, a quantity of the type of service or project, and a delivery schedule;
a supplier identification system configured to determine, using a second AI model comprised by the supplier identification system, a supplier list comprising at least one potential supplier based on, at least, the requirements and the supplier data, wherein determining the supplier list with the second model comprises identifying the at least one potential supplier that supplies the type of service or product based on the supplier data;
a questionnaire generator configured to generate, using a third AI model comprised by the questionnaire generator, a questionnaire based on, at least, the requirements and the questionnaire response history; and
a supplier evaluation system configured to:
determine a predicted performance for each of the at least one potential suppliers based on the respective questionnaire response for each of the at least one potential suppliers using a fourth AI model comprised by the supplier evaluation system, and
select a selected supplier from the at least one potential suppliers based on the predicted performance of each of the at least one potential suppliers.

12. The AI-based supplier management system of claim 11, wherein:
the questionnaire comprises one or more queries;
generating, using the questionnaire generator, the questionnaire comprises:
determining whether a past query comprised by the questionnaire response history exceeds a predefined time validity, and
removing the past query from consideration by the questionnaire generator in response to the past query exceeding the predefined time validity.

13. The AI-based supplier management system of claim 11, wherein:
the questionnaire comprises one or more queries;
none of the one or more queries duplicate a past query comprised by the questionnaire response history.

14. The AI-based supplier management system of claim 11, wherein the supplier identification system is further configured to:
determine a similarity metric between the requirements and historical requirements comprised by the historical data, wherein the historical requirements are associated with a first potential supplier,
wherein determining the supplier list further comprises including the first potential supplier in the supplier list in response to the similarity metric exceeding a similarity threshold.

15. The AI-based supplier management system of claim 11, wherein the supplier identification system is further configured to:
query, using a web interface, an online system to generate a list of new potential suppliers based on the requirements; and
aggregate data for each new potential supplier of the list of new potential suppliers to the supplier data.

16. The AI-based supplier management system of claim 11, wherein the supplier evaluation system is further configured to:
recommend a cost analysis for the selected supplier based on the requirements and the market data.

17. The AI-based supplier management system of claim 11, wherein the supplier evaluation system is further configured to:
determine, based on the requirements and the questionnaire, a set of criteria for evaluating a questionnaire response from each of the at least one potential suppliers.

18. The AI-based supplier management system of claim 17, wherein the determined predicted performance for each of the at least one potential suppliers is based on the set of criteria.

19. The AI-based supplier management system of claim 11, further comprising a performance monitoring system configured to:
determine a real-time performance for the selected supplier using a fifth AI model comprised by the performance monitoring system; and
generate an alarm in response to the real-time performance being below a performance threshold.

20. The AI-based supplier management system of claim 11, wherein:
the questionnaire generator comprises a chatbot configured to receive and transmit data from and to each of the at least one potential suppliers,
the questionnaire comprises a sequence of queries and any subsequent query in the sequence of queries is determined, using the chatbot, based on one or more responses to prior queries in the sequence of queries.
